(19) United States
(12) Patent Application Publication
(10) Pub. No.: US 2004/0145588 A1
(43) Pub. Date: Jul. 29, 2004

(54) System and method for reviewing an image in a video sequence using a localized animation window

(75) Inventor: Shashidhar Sathyanarayana, Union City, CA (US)

Correspondence Address: ORRICK, HERRINGTON & SUTCLIFFE, LLP, 4 PARK PLAZA, SUITE 1600, IRVINE, CA, 92614-2558, US

(73) Assignee: Scimed Life Systems, Inc.

(21) Appl. No.: 10/352,383

(22) Filed: Jan. 27, 2003

(51) Int. Cl. G06T 15/70

(52) U.S. Cl. 345/473

(57) ABSTRACT

An improved system and method creates a localized animation window of an image while a user is reviewing the image in a video sequence. In one example, a user may select a particular area within an image in a video sequence to be viewed as a localized animation window while the remaining area of the image is still.

### FIELD OF THE INVENTION

The field of the invention relates to imaging systems, and more particularly to an improved system and method for reviewing an image in a video sequence using a localized animation window.

### BACKGROUND OF THE INVENTION

When reviewing an image in a video sequence, e.g., a medical imaging system, the reviewer often has access to a sequence of images which can be played as an animation. Viewing the animated sequence often serves to contextualize the particular image under scrutiny and, hence, provides additional information. Often, the reviewing software associated with such imaging systems often comes provided with a means of viewing the animation.

In certain applications, the reviewer is interested in minutely examining a specific, localized region in the image within a small time-window of the entire recording. Currently available viewing software applications do not offer this facility. Accordingly, an improved system and method for reviewing images acquired with an imaging system would be desirable.

### BRIEF DESCRIPTION OF THE DRAWINGS

In order to better appreciate how the above-recited and other advantages and objects of the inventions are obtained, a more particular description of the inventions briefly described above will be rendered by reference to examples of specific embodiments, which are illustrated in the accompanying drawings, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely. Understanding that these drawings depict only example embodiments of the invention and are not therefore to be considered limiting of its scope, the invention will be described and explained with additional specificity and detail through the use of the accompanying drawings in which:

FIG. 1 illustrates an example of an image with a selected localized area;

FIG. 2 is a flowchart illustrating an example embodiment of an improved method.

### DETAILED DESCRIPTION OF THE PREFERRED EMBODIMENTS

Described below is a new system and method for reviewing an image within a video sequence of images. The image may be from any source, including but not limited to a medical ultrasound imaging device, a light-based imaging device such as Optical Coherence Tomography (OCT) and Optical Coherence Domain Reflectography (OCDR) imaging devices, and magnetic resonance imaging (MRI).

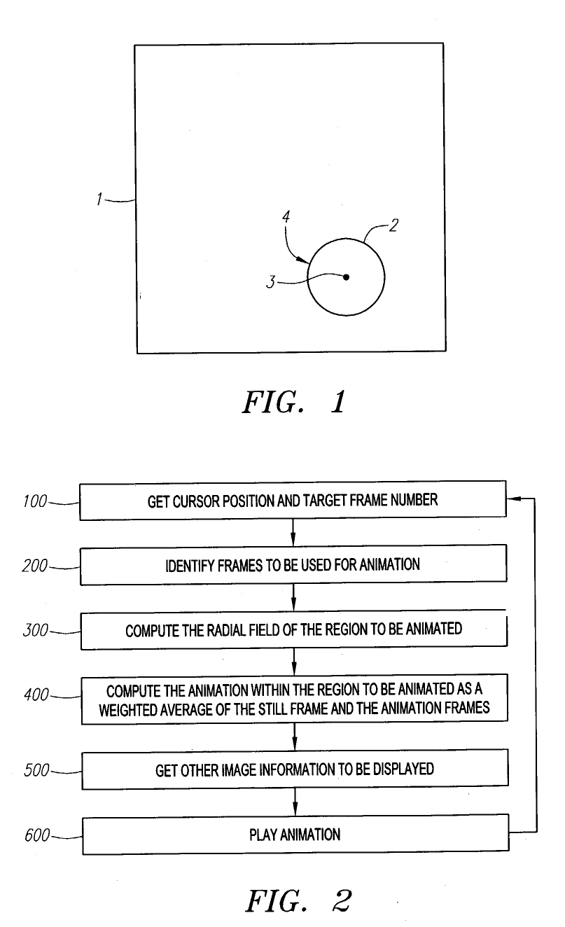

Turning to FIG. 1, as an example, in certain situations, when reviewing an image 1 within a video sequence, it may be desirable to view a particular area 2 of an image as a localized animated window and yet have the remaining area of the image 1 (e.g., the portion of the image outside the local area 2) remain still.

Turning to FIG. 2, a flowchart of an example embodiment of a method for selecting and viewing a particular area 2 as a localized animated window of an image 1 within a video sequence of images, or frames, is shown. An initial step is to determine the particular area 2 to be viewed. When using a display device having a controllable cursor to view the image, the location of the cursor may define the area where the localized animated window is desired, i.e., the particular area (block 100). Further, it may be desirable to obtain the particular frame, or image 1, where the cursor is located, i.e., the frame, or image 1, having the selected particular area 2 (block 100).

After obtaining the particular frame, or target frame (block 100), the next step is to identify the frames to be used for the animation window (block 200). One preferable approach to identifying the frames is to select a pre-determined number of frames before and after the target frame within the video sequence. This will provide the desired animation. Preferably, the video sequence is stored in a database, wherein each individual frame within the video sequence is accessible.

The next step is to compute the particular area 2 to be viewed as a localized animated window (block 300). Preferably this computation is done-radially around the central point 3 of the particular area, e.g., the precise location of the cursor, if the image is being viewed with a display device having a controllable cursor. The particular area may also be referred to as a radial field. The next step is to compute the animation within the particular area 2, localized animation window (block 400). It is preferable to have a gradual amount of animation from the central point 3 within the particular area 2 or localized animation window to the outer perimeter 4 of the particular area 2 or localized animation window, wherein the central point 3 has the most amount of animation, and the outer perimeter 4 has the least amount of animation. This is preferably computed as a weighted average of the target frame, or still frame, and the frames that provide the animation. This is also referred to as a radial-decay field. The reviewer would perceive the impression of a still frame exhibiting some activity under the cursor.

The next step is to obtain other information to be displayed (block 500). Then, the animation within the particular area 2, or localized animation window may be played (block 600). This method can be looped, i.e., in accordance with the method, a plurality of localized animated windows may be created. To do so, just select another particular area, e.g., move the cursor to another location, and repeat block 100.

This method may be applied on a video sequence where each frame of the video sequence may be individually captured and reviewed as a still frame. The video sequence is displayed with pixels in a display device, having a user controlled cursor. To select the particular area, a user may move the cursor to the desired location to be animated. The radial field surrounding the cursor is then calculated, wherein the area within the radial field is animated, using a predetermined number of frames before and after the frame being reviewed. The radial field is calculated for each frame being used in the animation, in accordance with the method described above. The result is that the pixels within the radial field change value based on the different radial fields of the predetermined frames, thus showing animation in a localized window, while the pixels outside of the radial field remain the same, based on the original frame selected for review. In one embodiment, the area within the radial field is animated equally throughout the area. Alternatively, the animation is gradual within the area, from the central point of the radial field to the outer perimeter of the radial field, the central point being the most animated and the outer perimeter being the least animated. In addition, any other variation in the amount of animation throughout the radial field is in accordance with an embodiment of the present invention.

This method would facilitate review for a variety of reasons, which include: (1) while taking advantage of the additional information which comes with the animation, the method will allow the reviewer to concentrate on the particular area of interest; (2) the reviewer will be able to take advantage of and interpret temporarily varying contextural information, which would be absent in still image; (3) more general implementations of this concept would allow for the display of text boxes containing localized values of image information; and (4) advanced implementations would also incorporate features such as a magnifier to zoom into the region-of- interest. An example of an imaging magnifier is disclosed in U.S. Pat. Nos. 6,063,032 and 6,217,517, both issued to Grunwald, which are both hereby incorporated by reference in their entirety for all purposes.

Although particular embodiments of the inventions have been shown and described, it will be understood that it is not intended to limit the inventions to the preferred embodiments, and it will be obvious to those skilled in the art that various changes and modifications may be made without departing from the spirit and scope of the inventions. Thus, the inventions are intended to cover alternatives, modifications, and equivalents, which may be included within the spirit and scope of the inventions as defined by the claims.

What is claimed is:

1. A method for viewing a portion of an image as a localized animated window, within a frame of a video sequence, having a plurality of frames:
selecting the portion of the image;
identifying a frame containing the portion of the image;
selecting a number of frames before and after the frame containing the portion of the image;
computing a radial field encompassing the portion of the image; and
playing the animation within the portion of the image, while the image other than the portion of the image remains still.

2. The method of claim 1, further comprising computing the amount of animation to be played within the portion of the image, wherein the amount of animation gradually decreases from the center of the portion of the image, which has the most animation, to the outer perimeter of the portion of the image, which has the least animation.

3. The method of claim 2, wherein the computing step computes the amount of animation as a weighted average of animated frames and still frames.
